(19) United States
(12) Patent Application Publication
(10) Pub. No.: US 2019/0095438 A1
(43) Pub. Date: Mar. 28, 2019

(54) AUTOMATING CONTENT GENERATION

(71) Applicant: NewsRx, LLC, Atlanta, GA (US)

(72) Inventors: Charles W. Henderson, Atlanta, GA (US); Alan D. Henderson, Watkinsville, GA (US); Chantay P. Jones, Marietta, GA (US); Kalani K. Rosell, New Haven, CT (US)

(73) Assignee: NewsRx, LLC

(21) Appl. No.: 15/712,868

(22) Filed: Sep. 22, 2017

(51) Int. Cl. G06F 17/30; H04L 29/08

(52) U.S. Cl. CPC G06F 17/30011; H04L 67/12; G06F 17/30286; G06F 17/30283; H04L 67/14

(57) ABSTRACT

Technologies for automating content generation are described. During content generation, interim content is transmitted to a research module. The resource module analyzes the interim content, determines additional information associated with the interim content and relationships between the additional information and the interim content. The additional information is transmitted to a content generator for potential addition to the content being generated.

### BACKGROUND

Documents, newsletters, websites and other sources of information are increasingly being generated by automated writing services, sometimes called “artificial intelligence journalists” when referring to the generation of news articles. However, automated sources of information can be applied to multiple types of information, not just news articles.

It is with respect to these and other considerations that the disclosure made herein is presented.

### SUMMARY

Technologies are described herein for automating content generation. Generally, a content generator invokes a generator module and a research module to generate content, such as a news article. While the generator module is generating content, the research module is receiving intermediate content from the generator module. The research module determines additional information associated with the intermediate content received from the generator module to generate additional content. The content generator determines if the additional content is to be added to the intermediate content being generated by the generator module.

It should be appreciated that the above-described subject matter can be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of technologies in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a system diagram illustrating an example content generator system.

FIG. 2 is a screen diagram showing an illustrative content structure.

FIG. 3 is a screen diagram showing an illustrative content data structure.

FIG. 4 is a screen diagram showing an illustrative modified content data structure.

FIG. 5 is a flow diagram showing aspects of a method disclosed herein for automating content generation.

FIG. 6 is a computer architecture diagram illustrating an illustrative computer hardware and software architecture for a computing system capable of implementing the technologies presented herein.

### DETAILED DESCRIPTION

The following detailed description is directed to technologies for automatically generating content. In conventional systems, content is generated using various algorithms known to those of ordinary skill in the relevant art. Some technologies, in an attempt to make the content appear to be written by a human, use algorithms to “enhance” the content. For example, an automated content generator may determine that the difference in points between a winning team and a losing team is so vast that the term “rout” is used rather than the term “win” when the article is generated. However clever and efficient these algorithms are, the articles are often still “flat” in that the articles provide no context beyond that which is received. In other words, the articles often reasonably provide information as to the “what” of the information, but do not provide information as to the “meaning” of the information.

In other automated or semi-automated systems, information in content is linked to information in other content in an attempt to achieve some level of “depth” of the content. For example, “wikis,” websites in which users generate content, often link information between various pages, sometimes using hyperlinks. In this manner, a user reading the content can select linked information to view additional information about the linked information. The user can explore by continually selecting linked information. The information is merely linked, however, as no meaning is provided by the link other than information is connected.

In still further conventional systems, additional information is provided to enhance generated content. For example, an automated source may generate an article about a sports event or a company's stock. Once the article is generated, a system is implemented whereby enhancements are made to the article in an attempt to make the article appear to be written by a human. For example, in the sports article description above whereby the term “rout” was used instead of “win,” the enhancement would be the difference in connotation between “rout” and “win.”

Various implementations of the presently disclosed subject matter provide technological improvements over conventional content generation technologies. For example, as noted above, conventional content generation technologies enhance content after a significant portion (or all) of the content is generated. While the method of doing so is straightforward, thus potentially saving money, these enhancement technologies are akin to driving without a map, arriving at a location, and then analyzing a resulting location. Information that may be gained during the trip is lost or may be as inaccurate as trying to retrace steps, rather than analyzing as a person moving forward. Thus, these technologies often produce content that do not provide enough information or have an improper focus, causing the need for human intervention or a re-performance of the content generation mechanism.

While the subject matter described herein is presented in the general context of program modules that execute in conjunction with the execution of an operating system and application programs on a computer system, those skilled in the art will recognize that other implementations can be performed in combination with other types of program modules. Generally, program modules include routines, programs, components, data structures, and other types of structures that perform particular tasks or implement particular abstract data types. Moreover, those skilled in the art will appreciate that the subject matter described herein can be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and in which are shown by way of illustration specific examples. Referring now to the drawings, aspects of technologies for generating content will be presented.

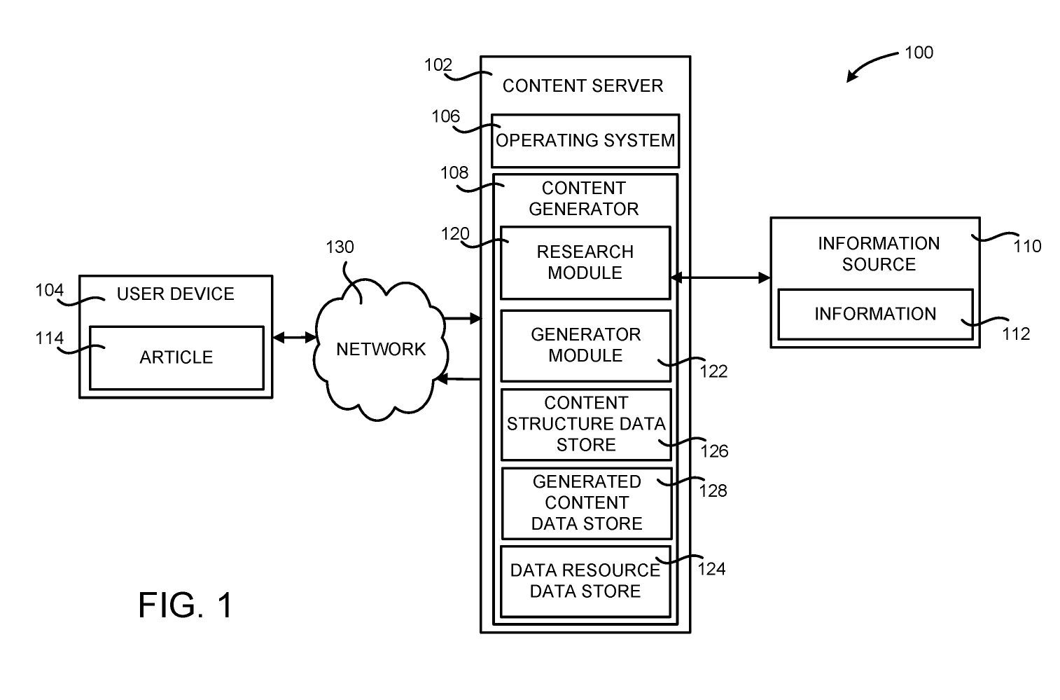

FIG. 1 is a diagram of an example content generation system 100 that may be used in various aspects of the presently disclosed subject matter. The content generation system 100 shown in FIG. 1 includes a content server 102 and user device 104. The content server 102 executes an operating system 106. The operating system 106 is a computer program for controlling the operation of the content server 102. The operating system 106 executes a content generator 108.

The content generator 108 receives information 112 from an information source 110. The information 112 can be of various formats and types. For example, the information source 110 can be an article, data, a website, and the like. The presently enclosed subject matter is not limited to any particular type of information 112. The information 112 is used to provide an article 114 to the user device 104. The presently disclosed subject matter is not limited to any particular length or format of the article 114. For example, the article 114 can be a news article, information in a webpage, a book, table of contents for a book, a report and the like. In some examples, the user device 104 is used by a user (not shown) to retrieve the article 114 about the information 112.

In order to generate the article 114, the content server 102 invokes a content generator 108. The content generator 108 receives the information 112 and generates the article using a process termed “connection generation.” The content generator 108 invokes a research module 120 and a generator module 122. In various examples, the research module 120 and the generator module 122 work in concert with the other to generate the article 114.

In some examples, connection generation is a process whereby relationships between facts in the information 112 and facts stored in the data resource data store 124 that may be potentially added to create the article 114 are determined while the article 114 is being generated.

In some examples, the process of connection generation enhances content in a manner different than conventional systems. For example, as noted above, in some conventional systems, the content is first generated and then content is added to enhance the content. However, also as noted above, this approach may not provide desirable content. In some instances, if enhancements or additional content are added after content is generated, important features of the content may not be fully researched and described, while meaningless or less important features of the content may inadvertently be made more important.

For example, a sports article written about a sporting event may enhance the content about the winning score, but inadvertently neglect the importance of the content relating to a team winning its division or a player achieving a milestone in his or her career. In some instances, if all aspects of the information 112 are enhanced after the article 114 is generated, the article 114 may be difficult to read, causing the article 114 to be rewritten in some instances.

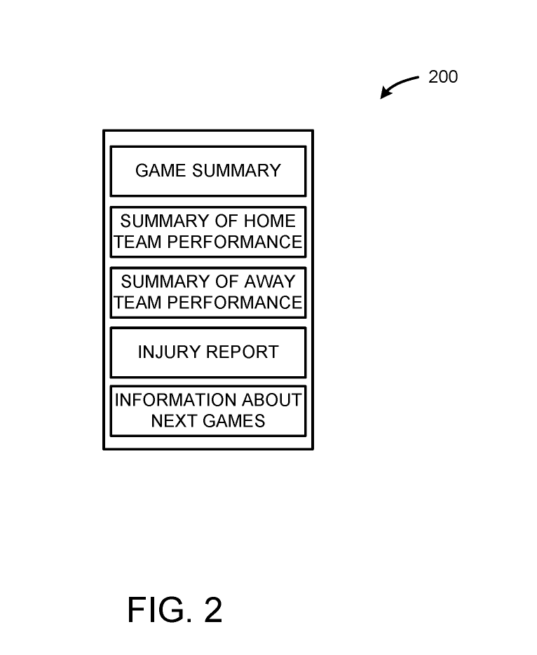

To generate the article 114, after receiving the information 112, the generator module 122 analyzes the information 112 to determine one or more themes of the article 114. A “theme” is a topic or subject of the article and is used to organize the article 114, described in more detail in FIG. 2. In some examples, a theme is the general subject matter of the article. For example, for information about a sports event, the theme can be “baseball game.” The article 114 can have more than one theme. In some examples, the article 114 can have individual sections, each with their own theme. The presently disclosed subject matter is not limited to any particular manner of theme. Once a theme is determined, the theme is used to determine an appropriate content structure, as explained in more detail in FIG. 2.

In FIG. 2, a content structure 200 is provided based on a theme. As mentioned above, in some examples, the content structure 200 can be described as a basic framework as to how the article 114 is to be constructed. For example, the content structure 200 provided in FIG. 2 is for the article 114 related to a baseball game. The example content structure 200 includes a section for a game summary, a section for a summary of the home team performance, a section for a summary of the away team performance, a section for injuries, and a section for information about next games. Each of the sections of the content structure 200 can be paragraphs, sentences, multiple paragraphs, and the like.

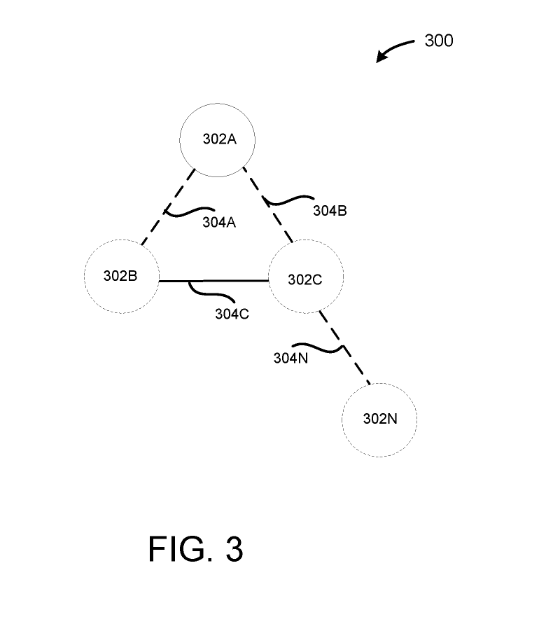

In some examples, if the article 114 is created using simply the content structure 200, the article 114 may appear or read like a computer-generated article. The article 114 will merely be rote from the information 112 provided to create the article 114. In some examples, conventional systems may enhance the sections of the content structure 200 once generated. For example, conventional systems may analyze the game summary and determine that the score had such a margin that terms like “win” should be replaced with “rout,” which connote a larger difference of score. In a distinctly different manner, the content structure 200 of FIG. 2 is associated with a content data structure, such as the one illustrated in FIG. 3.

FIG. 3 is an illustration of a content data structure 300 that can be associated with a content structure, such as the content structure 200 of FIG. 2. The content data structure 300 is used by the content generator 108 to organize additional facts and relationships associated with content inserted into the content structure 200 of FIG. 2.

The content data structure 300 of FIG. 3 includes nodes 302A-302N (hereinafter referred to collectively as “the nodes 302” and individually as “the node 302A,” “the node 302B,” and so forth). The nodes 302 are associated with each other by connections 304A-304N (hereinafter referred to collectively as “the connections 304” and individually as “the connection 304A,” “the connection 304B,” and so forth). The nodes 302 and connections 304 are representative of the association of information (or relationships).

Using the example started above in which the article 114 is a sports article using the content structure 200 of FIG. 2, the content data structure 300 initially includes only one node, node 302A. The node 302A is interim content received from the generator module 122 upon which additional information is gleaned. During the generation of content, the research module 120 transmits interim content to the research module 120. In the example provided in FIG. 3, the node 302A can be the number of hits of a particular baseball player. Initially, there may be no connections 304 between the node 302A and any other node. Further, because node 302A represents interim content, the only node in content data structure 300 may be the node 302A.

To enhance the article 114 generated by the content generation system 100 of FIG. 1, which the generator module 122 of FIG. 1 is generating the article using the content structure 200 of FIG. 2, the research module 120 of FIG. 1 researches information using the data resource data store 124 of FIG. 1 relating to the node 302A to generate a content data structure from an initial content data structure. The data resource data store 124 is one or more sources of data (or information) such as an online encyclopedia, reference, dictionary, and the like. It should be noted that the data resource data store 124 is illustrated as being part of the content server 102, but the presently disclosed subject matter is not limited to that configuration, as external or internal sources of information may be used.

In an example of content data structure generation for a sports-related article, the research module 120 may determine that the number of hits in a ball game or a total number of hits by a player is significant. The research module 120 thereafter instantiates the node 302B and the connection 304A, associating the node 302A with the information that the information associated with node 302A represents a significant number. The research module 120 then determines the number of hits that is significant (for example, a baseball record or a number of hits that very few players have reached). The research module 120 then instantiates the node 302C and the connections 304B and 304C.

The research module 120 then determines the players' names that have achieved the number of hits represented by node 302C, and memorializes that information by instantiating node 302N and connection 304N. Thus, for the information represented by node 302A, the research module 120 has “gone deep” by determining the information associated with nodes 302B, 302C, and 302N, and their connections 304A, 304B, 304C, and 304N. The connections 304 can be thought of as “meaning.” Thus, while the content generation system 100 of FIG. 1 is collecting the information 112 from the information source 110, and organizing the information 112 into the content structure 200 of FIG. 2, the research module 120 is determining the content data structure 300 containing information that can be used to enhance the article 114.

The number of nodes 302 and connections 304 removed from the node representing the interim content, node 302A, represents a depth of informational research. In some examples, due to various factor such as processing or operational limitations of the content server, the number of nodes 302 and the number of connections 304 removed from the node 302A may be limited. For example, the content generator 108 can receive an input that the article 114 is to have a size or length limitation (e.g. 1000 words). The content generator 108 can receive this limitation as a connection 304 limitation or a node 302 limitation and, for example, limit the research module 120 to only two connections 304 removed from the node 302A, thus limiting the potential amount of content inserted into the article 114.

Returning to FIG. 1, after the content data structure 300 of FIG. 3 is determined, the content generator 108 determines if the content structure 200 should be modified. The reasons for modification can vary. For example, in a sports context, record-setting performances should likely be emphasized. In another example relating to drug research, certain areas of the world or numbers of individuals suffering from a particular disease may be a point of emphasis if the number is of a certain amount.

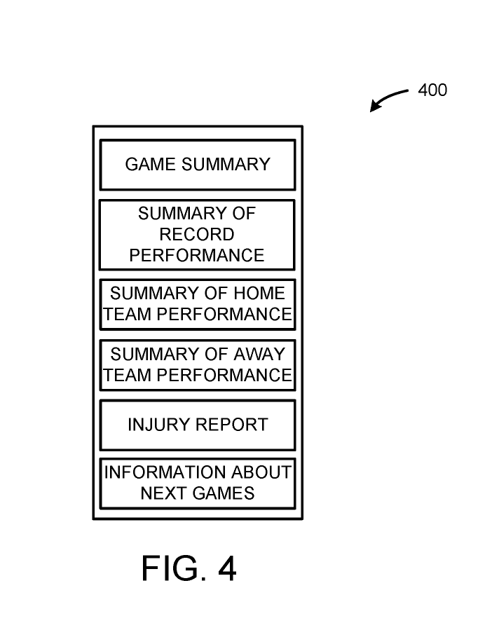

If the content generator 108 determines that the content structure 200 of FIG. 2 should be modified, the content generator 108 receives an input from the research module 120 as to the information that may change the content structure 200, resulting in a modified content structure 400 illustrated in FIG. 4.

In FIG. 4, the modified content structure 400 is a modified form of the content structure 200 of FIG. 2. In FIG. 4, the content generator 108 has determined that the “Summary of Record Performance” should be at least the second section of the article 114, emphasizing its importance to the article. The remaining sections of the content structure 200 of FIG. 2 are placed lower in the hierarchy of the content structure 200.

Returning to FIG. 1, the content generator 108 determines if the information provided in the content data structure 300 is to be inserted into the article 114. The content generator 108 analyzes the information provided in the content data structure 300 using various factors such as length (e.g. the number of words or letters) of the information provided in the content data structure 300. If the content generator 108 determines that the information provided in the content data structure 300 is to be inserted into the article 114, the generator module 122 incorporates the changes provided by the research module 120. The process of sending interim content to the research module 120 continues until the article 114 is completed. It should be noted that the content data structure 300 can itself be interim content. The content structure 200 and the modified content structure 400 are stored in a content structure data store 126. The content structure data store 126 has stored therein one or more content structures, such as the content structure 200 and the modified content structure 400.

If the modified content structure 400 has been modified in a manner different than what has been used before, for example, by receiving input from a human editor that the modified content structure 400 should be used, the content generator 108 can update other content structures stored in the content structure data store 126 used for similarly situated articles, such as articles having the same subject matter. The content generator 108 can continually update content structures stored in the content structure data store 126 as new content structures are designed and, in some examples, approved for use. For example, sports-related articles generated in the future may be constructed using the modified content structure 400 if the content data structure of the new article is similar to the content data structure 300 of FIG. 3.

As noted above, the content generator 108 can use the research module 120, with the generator module 122, to generate the article 114. To generate the content data structure 300 and, eventually, the article 114, the content generator can use various processes, such as, but not limited to, observation (or data research), discovery, “going deep,” making connections, quality, quantity, and insight.

A process performed by the content generator 108 is the process of data research. The data research process can be performed by the research module 120 when, inter alia, constructing the content data structure 300 of FIG. 3. The data researched can include data contained in the information 112 and outside of the information. For example, the data research process for an event can include research about data directly pertaining to the event (such as the number of cars involved in the accident) and data outside of the event (such as the number of accidents at that particular location).

Another process that can be performed by the content generator 108 is the process of discovery. The process of discovery is the realizing of data generated by the data research process. For example, the content generator 108 can initiate the data research process by initiating a search of records relating to accidents in a particular location. The process of discovery is finding the data relating to the search processes commenced in the data research process. In terms of examples provided above, the data research process and the discovery process are used to generate nodes of the content data structure 300.

The process of “going deep” involves the content generator 108 using the data determined in the discovery process to start a new data research process. For example, in FIG. 3, the nodes 302A and 302C can be rationalized as two levels of information. The initial data, represented by node 302A, is a first or base level. The node 302C is a second level. The content generator 108 can initiate a data research process on node 302C and determine information represented by node 302N. Thus, in relation to node 302A, node 302N is two levels removed from node 302A.

The content generator 108 can continue this process of building the content data structure 300, adding additional levels to various nodes 302. It should be noted, however, that the content generator 108 may be limited in the process of “going deep,” e.g. building levels, by various factors such as the desired length of the article 114, the capabilities (such as processing power) of the content server 102, the amount of information available to the content generator 108, and the like. The content generator 108 can also receive a limiting input, such as a human input, a node limitation, or a connection limitation, that the number of levels is excessive, using that input as an input for a modified content structure, such as the modified content structure 400 of FIG. 4.

The process of making connections is described by way of example in FIG. 3. The connections 304 are used to represent a relationship between the information represented by the nodes 304. The connections 304 are used by the content generator 108 to organize the article 114. For example, the connection 304N, representing a relationship between nodes 302C and 302N, can be a strong or important relationship (such as a merger of a competitor in a financial-related article) that should be emphasized, which the connections 304A, 304B, and 304C may be deemphasized. The process of quality checks information for accuracy. Although quality and accuracy may be important, the content generator 108 may be limited in its ability to check information. The article 114 is thereafter finalized, stored in a generated content data store 128, and transmitted via a network 130 to the user device 104.

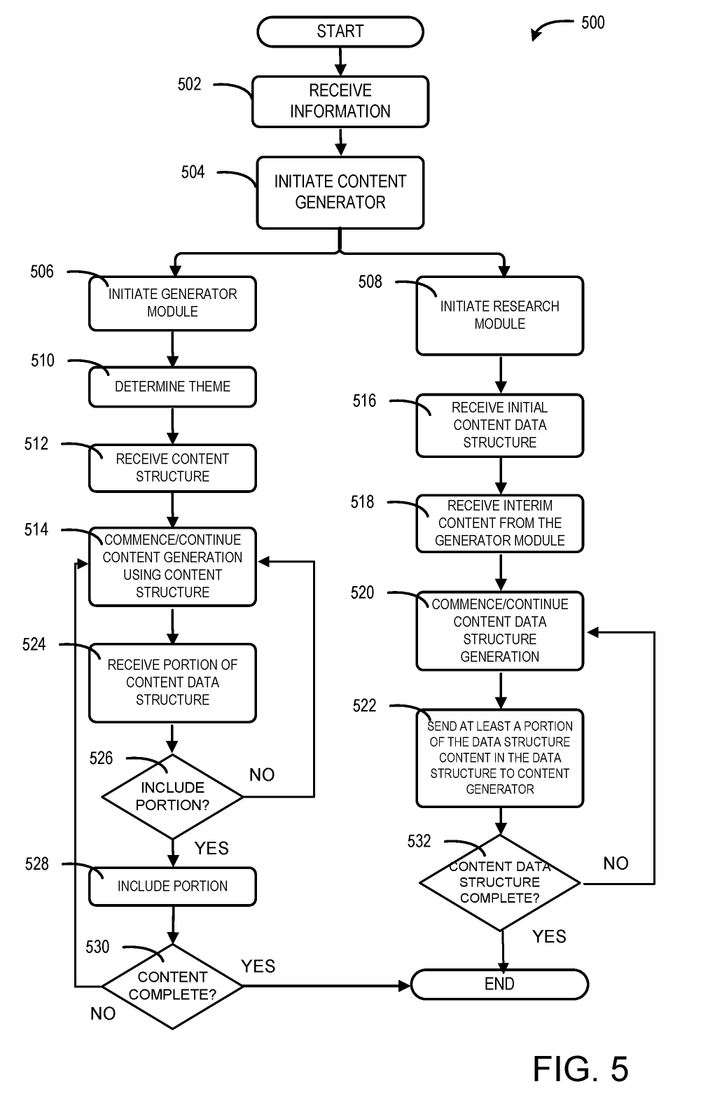

FIG. 5 is a flow diagram showing aspects of a method 500 disclosed herein for generating content, such as the article 114. The presently disclosed subject matter is not limited to any particular length or format of the article 114. For example, the article 114 can be a news article, information in a webpage, a book, a table of contents for a book, a report and the like. It should be understood that the operations of the method 500 are not necessarily presented in any particular order and that performance of some or all of the operations in an alternative order(s) is possible and is contemplated. The operations have been presented in the demonstrated order for ease of description and illustration. Operations can be added, omitted, and/or performed simultaneously, without departing from the scope of the appended claims.

It also should be understood that the illustrated method 500 can be ended at any time and need not be performed in its entirety. Some or all operations of the method 500, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like. Computer-storage media does not include transitory media.

Thus, it should be appreciated that the logical operations described herein can be implemented as a sequence of computer implemented acts or program modules running on a computing system, and/or as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules can be implemented in software, in firmware, in special purpose digital logic, and any combination thereof.

For purposes of illustrating and describing the technologies of the present disclosure, the method 500 disclosed herein is described as being performed by the content server 102 and user device 104 via execution of computer executable instructions such as, for example, the content generator 108. As explained above, the content generator 108 can include functionality for generating content such as the article 114.

While the method 500 is described as being provided by the content server 102, it should be understood that the content server 102 can provide the functionality described herein via execution of various application program modules and/or elements. Additionally, devices other than, or in addition to, the content server 102 can be configured to provide the functionality described herein via execution of computer executable instructions other than, or in addition to, the content generator 108. As such, it should be understood that the described configuration is illustrative, and should not be construed as being limiting in any way.

The method 500 begins at operation 502, where information 112 is received from an information source 110. The information source 110 can be one or more documents, web pages, scholarly articles, news events, and the like.

The method 500 continues to operation 504, where the content generator 108 is initiated. The content generator 108 performs various functions. For example, the content generator 108 receives and transmits content, organizes various modules, and receives input regarding content. The content generator 108 also determines if content generated by the research module 120 is to be included in the article 114.

The method 500 continues to operations 506 and 508, where the generator module 122 and the research module 120 are started. As discussed above, various conventional technologies for generating content implement a linear approach to generating the content. For example, content is generated from information and thereafter enhanced by reviewing the finished product.

In a distinctly different manner, according to various configurations described herein, the generator module 122 and the research module 120 are initiated at the same time. As described above and in additional detail below, the generator module 122 generates basic content from the information 112. For example, the information may be numbers relating to a sports game, such as baseball. The research module 120 is configured to receive interim information from the generator module 122. As used herein, “interim information” or “interim content” is content generated by the generator module 122 while the article 114 is being generated. For example, the content generator 108 may receive a baseball score and the teams as the information 112. The generator module 122 receives the information 112 and, while generating the article 114, transmits the interim information to the research module 120.

The method 500 continues to operation 510, where a theme is determined. The theme can be the subject matter of the information 112, an intended use of the article 114, and the like. To determine a theme, in some examples, the content generator 108 analyzes the information 112. For example, the content generator 108 may determine the information 112 is a sports score, a financial report, a traffic report, an academic research paper, and the like. In other examples, the content generator 108 can receive an input that the article 114 is to be used for a humorous article. The presently disclosed subject matter is not limited to any particular manner of determining a theme.

The method 500 continues to operation 512, where a content structure 200 is received. The content structure 200 is an organizational structure of the content to be inserted into the article 114. The content structure 200 is based on the theme determined in operation 510.

The method 500 continues to operation 514, where the generator module 122 commences content generation. For example, the content generator 108 may receive the following information 112: Scientists in Belgium report that Mary has discovered a new element. Marium. The information 112 is sparse and may not provide enough information to generate the article 114. Thus, commencing content generation, the generator module 122 receives the content structure 200 and commences inserting information into the content structure 200. For example, the content structure 200 can be associated with a scientific discovery theme.

To enhance the article while the generator module 122 generates the article 114, the method 500 continues to operation 516 from operation 508, where the initial content data structure 300 is received by the research module 120, and operation 518, where interim content is received by the research module 120 from the generator module 122. As noted above, the node 302A is an example of interim content received from the generator module 122.

The method 500 continues to operation 520, where the research module 120 receives the interim content from the generator module 122 and commences the construction of the content data structure 300. The content data structure 300 includes information relevant to the interim content. The content data structure 300 represents the relationships between additional information researched from the interim content. For example, continuing with the information about Mary discovering a new element, Marium, the research module 120 can access the data resource data store 124 to determine information about one of the first pieces of information, Mary. Records of Mary can be accessed to determine where Mary is, her educational background, and other experiments she has performed.

Continuing with this example using the content data structure 300 of FIG. 3, the interim content Mary can be node 302A. A prior experiment or discovery can be node 302B and information about the experiment of node 302B is memorialized in node 302C. The connections 304A and 304C show the relationship between the nodes 302A, 302B, and 302C. Further research by the research module 120 may determine a relationship between the node 302C and the node 302A, represented by the connection 304B, indicating the prior research may have led to the discovery of Marium.

The method 500 continues to operation 522, where at least a portion of the content in the content data structure 300 is provided to the generator module 122.

The method 500 continues to operation 524 from operation 514, where the generator module 122 receives the content in the content data structure 300 from the research module 120. A determination is made at operation 526 whether or not to include the content in the content data structure 300. At operation 526, if the content is not to be included, the method 500 continues to operation 514 where the content generation is continued.

If at operation 526 the determination is made that the content is to be included, the method 500 continues to operation 528 where the portion is included.

The method 500 continues to operation 530, where a determination is made as to whether or not the content generation process is complete. If the determination at operation 530 is that the content generation process is complete, the method 500 thereafter ends. If the determination at operation 530 is that the content generation process is not complete, the method continues to operation 514, where the content generation is continued.

The method 500 at operation 532 determines if the content data structure 300 is complete. If the content data structure 300 is not complete, the research module 120 can continue generating the content data structure 300. If the content data structure 300 is complete, the process of generating the content data structure 300 ends. The method 500 can thereafter end or can continue at operation 514.

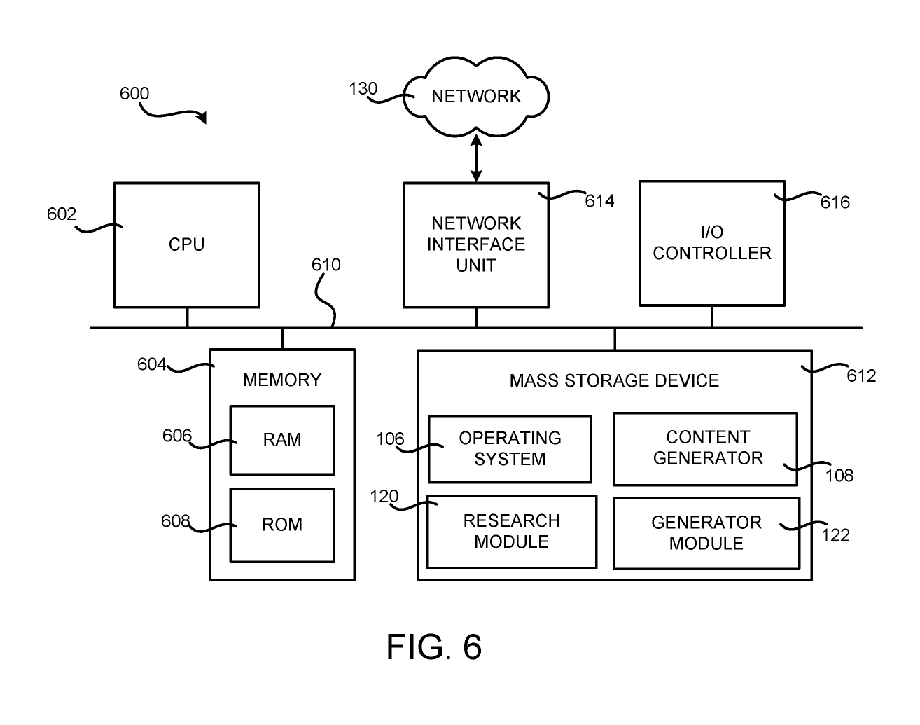

FIG. 6 illustrates an illustrative computer architecture 600 for generating content. Thus, the computer architecture 600 illustrated in FIG. 6 illustrates an architecture for a server computer, mobile phone, a smart phone, a desktop computer, a netbook computer, a tablet computer, and/or a laptop computer. The computer architecture 600 can be utilized to execute any aspects of the software components presented herein.

The computer architecture 600 illustrated in FIG. 6 includes a central processing unit 602 (“CPU”), a system memory 604, including a random-access memory 606 (“RAM”) and a read-only memory (“ROM”) 608, and a system bus 610 that couples the memory 604 to the CPU 602. A basic input/output system containing the basic routines that help to transfer information between elements within the computer architecture 600, such as during startup, is stored in the ROM 608. The computer architecture 600 further includes a mass storage device 612 for storing the operating system 106 and one or more application programs or data stores including, but not limited to, the content generator 108, the research module 120, and the generator module 122.

The mass storage device 612 is connected to the CPU 602 through a mass storage controller (not shown) connected to the bus 610. The mass storage device 612 and its associated computer-readable media provide non-volatile storage for the computer architecture 600. Although the description of computer-readable media contained herein refers to a mass storage device, such as a hard disk or CD-ROM drive, it should be appreciated by those skilled in the art that computer-readable media can be any available computer storage media or communication media that can be accessed by the computer architecture 600.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

By way of example, and not limitation, computer storage media can include volatile and non-volatile, removable and non-removable media implemented in any method or technology for storage of information such as computer-readable instructions, data structures, program modules or other data. For example, computer storage media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 600. For purposes the claims, a “computer storage medium” or “computer-readable storage medium,” and variations thereof, do not include waves, signals, and/or other transitory and/or intangible communication media, per se. For the purposes of the claims, “computer-readable storage medium,” and variations thereof, refers to one or more types of articles of manufacture.

According to various configurations, the computer architecture 600 can operate in a networked environment using logical connections to remote computers through a network such as the network 130. The computer architecture 600 can connect to the network 130 through a network interface unit 614 connected to the bus 610. It should be appreciated that the network interface unit 614 can also be utilized to connect to other types of networks and remote computer systems. The computer architecture 600 can also include an input/output controller 616 for receiving and processing input from a number of other devices, including a keyboard, mouse, or electronic stylus (not shown in FIG. 6). Similarly, the input/output controller 616 can provide output to a display screen, a printer, or other type of output device (also not shown in FIG. 6).

It should be appreciated that the software components described herein can, when loaded into the CPU 602 and executed, transform the CPU 602 and the overall computer architecture 600 from a general-purpose computing system into a special-purpose computing system customized to facilitate the functionality presented herein. The CPU 602 can be constructed from any number of transistors or other discrete circuit elements, which can individually or collectively assume any number of states. More specifically, the CPU 602 can operate as a finite-state machine, in response to executable instructions contained within the software modules disclosed herein. These computer-executable instructions can transform the CPU 602 by specifying how the CPU 602 transitions between states, thereby transforming the transistors or other discrete hardware elements constituting the CPU 602.

Encoding the software modules presented herein can also transform the physical structure of the computer-readable media presented herein. The specific transformation of physical structure can depend on various factors, in different implementations of this description. Examples of such factors can include, but are not limited to, the technology used to implement the computer-readable media, whether the computer-readable media is characterized as primary or secondary storage, and the like. For example, if the computer-readable media is implemented as semiconductor-based memory, the software disclosed herein can be encoded on the computer-readable media by transforming the physical state of the semiconductor memory. For example, the software can transform the state of transistors, capacitors, or other discrete circuit elements constituting the semiconductor memory. The software also can transform the physical state of such components in order to store data thereupon.

As another example, the computer-readable media disclosed herein can be implemented using magnetic or optical technology. In such implementations, the software presented herein can transform the physical state of magnetic or optical media, when the software is encoded therein. These transformations can include altering the magnetic characteristics of particular locations within given magnetic media. These transformations can also include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 600 in order to store and execute the software components presented herein. It also should be appreciated that the computer architecture 600 can include other types of computing devices, including hand-held computers, embedded computer systems, personal digital assistants, and other types of computing devices known to those skilled in the art. It is also contemplated that the computer architecture 600 might not include all of the components shown in FIG. 6, can include other components that are not explicitly shown in FIG. 6, or might utilize an architecture completely different than that shown in FIG. 6.

Based on the foregoing, it should be appreciated that technologies for automating content generation have been disclosed herein. Although the subject matter presented herein has been described in language specific to computer structural features, methodological and transformative acts, specific computing machinery, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes can be made to the subject matter described herein without following the example configurations and applications illustrated and described, and without departing from the true spirit and scope of the present invention, aspects of which are set forth in the following claims.

What is claimed is:

1. A computer-implemented method for generating an article, the method comprising:
receiving information;
determining a theme for the information;
determining a content structure based on the theme;
initiating a generator module and a research module;
commencing, at the generator module, content generation using the content structure;
during content generation by the generator module, receiving at the research module from the generator module interim content;
receiving an initial content data structure;
commencing, at the research module, content data structure generation by determining data structure content from the interim content received from the generator module;
receiving, at the generator module, the data structure content from the generator module; and
continuing content generation for the article at the content generator.

2. The method of claim 1, wherein content data structure generation comprises instantiating a plurality of nodes and a plurality of connections between one or more of the plurality of nodes.

3. The method of claim 2, further comprising receiving a connection limitation to limit a number of connections to be instantiated.

4. The method of claim 2, further comprising receiving a node limitation to limit a number of nodes to be instantiated.

5. The method of claim 1, further comprising including the data structure content into the content generation by the generator module.

6. The method of claim 1, further comprising modifying the content structure to generate a modified content structure.

7. The method of claim 1, further comprising checking information in article for accuracy.

8. The method of claim 1, wherein determining data structure content comprises accessing a data resource data store.

9. A computer-readable storage medium having computer-executable instructions stored thereupon that, when executed by a computer, cause the computer to:
receive information;
determine a theme for the information;
determine a content structure based on the theme;
initiate a generator module and a research module;
commence, at the generator module, content generation using the content structure;
during content generation by the generator module, receive at the research module from the generator module interim content;
instantiate an initial content data structure;
commence, at the research module, content data structure generation by determining data structure content from the interim content received from the generator module;
receive, at the generator module, the data structure content from the generator module; and
continue content generation at the content generator.

10. The computer-readable storage medium of claim 9, wherein content data structure generation comprises computer-executable instructions that, when executed by the computer, cause the computer to instantiate a plurality of nodes and a plurality of connections between one or more of the plurality of nodes.

11. The computer-readable storage medium of claim 10, further comprising computer-executable instructions that, when executed by the computer, cause the computer to receive a connection limitation to limit a number of connections to be instantiated.

12. The computer-readable storage medium of claim 10, further comprising computer-executable instructions that, when executed by the computer, cause the computer to receive a node limitation to limit a number of nodes to be instantiated.

13. The computer-readable storage medium of claim 9, further comprising computer-executable instructions that, when executed by the computer, cause the computer to include the data structure content into the content generation by the generator module.

14. The computer-readable storage medium of claim 9, further comprising computer-executable instructions that, when executed by the computer, cause the computer to modify the content structure to generate a modified content structure.

15. The computer-readable storage medium of claim 9, further comprising computer-executable instructions that, when executed by the computer, cause the computer to check information in the article for accuracy.

16. The computer-readable storage medium of claim 9, wherein determining data structure content comprises computer-executable instructions that, when executed by the computer, cause the computer to access a data resource data store.

17. A system comprising:
a processor; and
a computer-readable storage medium in communication with the processor, the computer-readable storage medium having computer-executable instructions stored thereupon which, when executed by the processor, cause the processor to:
receive information;
determine a theme for the information;
determine a content structure based on the theme;
initiate a generator module and a research module;
commence, at the generator module, content generation using the content structure;
during content generation by the generator module, receive at the research module from the generator module interim content;
instantiate an initial content data structure;
commence, at the research module, content data structure generation by determining data structure content from the interim content received from the generator module;
receive, at the generator module, the data structure content from the generator module; and
continue content generation at the content generator.

18. The system of claim 17, wherein content data structure generation comprises computer-executable instructions that, when executed by the processor, instantiate a plurality of nodes and a plurality of connections between one or more of the plurality of nodes.

19. The system of claim 18, further comprising computer-executable instructions that, when executed by the processor, receive a connection limitation to limit a number of connections to be instantiated and a node limitation to limit a number of nodes to be instantiated.

20. The system of claim 17, further comprising computer-executable instructions that, when executed by the processor, modify the content structure to generate a modified content structure.
